(19) United States
(12) Patent Application Publication
(10) Pub. No.: US 2010/0115824 A1
(43) Pub. Date: May 13, 2010

(54) Rodent Snap Action Trap

(76) Inventor: Steven Frisch, Brooklyn, NY (US)

Correspondence Address: Bernard Malina;Malina & Associates, PLLC, 17th Floor, 444 Madison Avenue, New York, NY, 10022, US

(21) Appl. No.: 12/575,693

(22) Filed: Oct. 8, 2009

Related U.S. Application Data
(63) Continuation of application No. 61/103,661, filed on Oct. 8, 2008.

(51) Int. Cl. A01M 23/24

(52) U.S. Cl. 43/81

(57) ABSTRACT

A trap for rodents includes a trigger plate having an adhesive layer. A removable release layer covers the adhesive layer prior to use.

The present application claims priority from Provisional Patent Application Ser. No. 61/103,661 filed on Oct. 8, 2008, entitled “Improved Rodent Snap Action Trap.”

### Field of the Invention

The present invention relates generally to the field of rodent traps and more particularly to an improved rodent snap action trap.

### BACKGROUND OF THE INVENTION

Conventional snap action rodent traps typically include a trigger, commonly in the form of a flat metal plate, which when depressed, causes the release of a spring-loaded trap arm which strikes and thereby traps the rodent. The trigger plate usually has a bait mounted on the trigger plate with the expectation that when the rodent attempts to seize the bait, it will cause sufficient depression of the trigger to release the spring-loaded snap arm to strike and trap the rodent.

Recently, it has been found that rodents have learned to lightly snare the bait from the trigger plate, i.e., without applying sufficient force to the trigger plate to cause release of the spring-loaded trap arm to trap the rodent.

### OBJECTS AND SUMMARY OF THE INVENTION

It is an object of the present invention to provide a rodent snap action trap which prevents a rodent from removing the bait without activating the trap.

The present invention contemplates modifying the trigger plate on a conventional rodent snap trap to prevent the rodent from ensnaring the bait from the trigger plate without causing sufficient depression of the trigger plate to produce snap action trapping of the rodent. This is accomplished by coating the trigger plate with a thin layer of adhesive sufficient to snag the rodent's paw to prevent easy disengagement from the trigger plate. Thus, when the rodent's paw touches the trigger plate, it will become ensnared by the glue layer on the trigger plate. This adhesive layer will momentarily hold the rodent in place while the trap is set off. Further, this will cause the rodent to try to effect extrication from the glue layer which will usually cause the rodent to place greater force on the trigger plate by its entrapped paw and any other body elements which the rodent employs in an attempt to effect extrication thereby ensuring prompt actuation of the trigger mechanism and entrapment of the rodent. The invention will increase the efficacy of the trap by reducing the number of “runaway” rodents, i.e., rodents which seize the bait without setting off the trap.

### BRIEF DESCRIPTION OF THE DRAWINGS

FIG. 1 is an overall perspective view of a trigger plate of an improved rodent snap action trap with the trigger plate shown removed from the conventional portions of the snap action trap and with the release paper shown removed.

FIG. 2 is an elevation view taken along the line 2-2 of FIG. 1,

### DETAILED DESCRIPTION OF THE INVENTION\

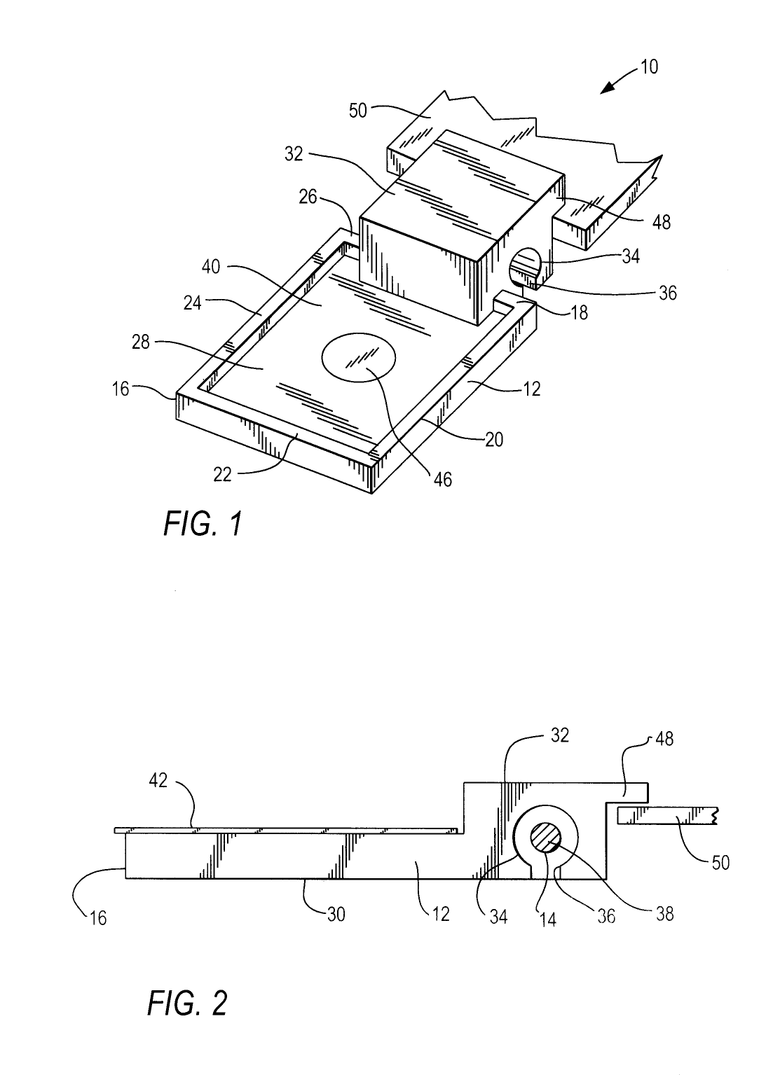

With reference to the drawings, there is shown in FIGS. 1 and 2 an improved rodent snap action trap 10 which features an improved trigger plate 12. In FIG. 1, the trigger plate 12 has been removed from the conventional portions of the trap and with the trigger plate 12 shown removed from the axle 14 of the trap 10. The features of construction of the trap 10 which have not been illustrated are conventional in nature.

The trigger plate 12 has a tray portion 16 with an upturned lip or upturned flange portions 18, 20, 22, 24 and 26 forming an open trough or open container 28. The lip portions 18, 20, 22, 24 and 26 project upwardly from a base 30. An upwardly projecting support portion 32 includes a through bore 34 with a narrow opening 36.

The narrow opening 36 allows the trigger plate 12 to be snapped onto the axle 38 of a snap action rodent trap 10. The trigger plate 12 is thus pivotally mounted on axle 38.

The trough 28 is filled with a non-drying adhesive 40 which is covered by a layer of release paper 42. The release paper 42 is removed prior to use. During use, bait 46 is placed on the adhesive layer 40.

The support portion engages catch portion 50 of the conventional snap action trap 10.

When a rodent's paw touches the trigger plate 12 it will become ensnared by the adhesive later 40. Movement of the rodent causes the flange portion 42 to release a catch portion 44 of the conventional snap action trap and sets off the trap.

The foregoing specific embodiments of the present invention as set forth in the specification herein are for illustrative purposes only. Various deviations and modifications may be made within the spirit and scope of this invention, without departing from a main theme thereof.

What is claimed is:

1. An improved rodent snap action trap comprising:
a tray portion, and an adhesive layer deposited on the trap portion.

2. The trap as claimed in claim 1 wherein said tray portion comprises:
a trough.

3. The trap as claimed in claim 1 wherein said tray portion comprises:
a plurality of upturned flanges.

4. The trap as claimed in claim 1 wherein said tray portion comprises:
a through bore portion.

5. The trap as claimed in claim 1 wherein said trap comprises:
an axle, and
a catch portion and wherein said trap portion engages said catch portion

6. The trap as claimed in claim 5 wherein said tray portion is pivotally mounted on said axle
